(19) United States
(12) Patent Application Publication
(10) Pub. No.: US 2006/0158708 A1
(43) Pub. Date: Jul. 20, 2006

(54) Apparatus and method for fabricating three-dimensional nano/micro structures

(75) Inventors: Hong Hocheng, Hsinchu City (TW); Chi-Hung Liao, Tainan City (TW)

Correspondence Address: SILICON VALLEY PATENT GROUP LLP, 2350 MISSION COLLEGE BOULEVARD, SUITE 360, SANTA CLARA, CA, 95054, US

(73) Assignee: Hong Hocheng, Hsinchu City (TW)

(21) Appl. No.: 11/077,260

(22) Filed: Mar. 9, 2005

(30) Foreign Application Priority Data
Jan. 17, 2005 (TW) 094101351

(51) Int. Cl. G02B 26/08

(52) U.S. Cl. 359/196

(57) ABSTRACT

An apparatus for fabricating a three-dimensional nano/micro structure is provided in the present invention. The apparatus includes a laser source for providing a laser beam, a light-splitting system for generating at least a first light beam and a second light beam from the laser beam, a lens for focusing the first light beam and the second light beam on a focus so as to form an interference pattern thereon and a holder for carrying a substrate having plural first and second nano/micro particles therein. Through the present invention, the first and second nano/micro particles are formed as a two-dimensional structure corresponding to the interference pattern to be further deposited on the substrate, so that the three-dimensional nano/micro structure is successively formed thereby with a high efficiency and precision.

### FIELD OF THE INVENTION

The present invention relates to an apparatus and a method for fabricating a nano/micro structure, and more particularly to an apparatus and a method for fabricating a three-dimensional nano/micro structure.

### BACKGROUND OF THE INVENTION

Techniques for fabricating nano/micro structures with various materials are highly improved for meeting the increasing demands therefore. The accuracy in a degree of micrometer, nanometer or even an atomic level is applied in the mentioned techniques, such as the micro-contact printing, the scanning probe-based technique, the ink jet printing, the photo-lithography and the laser tweezers, for fabricating the nano/micro structure.

The scanning probe-based technique plays an important role for improving the application of the nano/micro technology. In order to identify the surface property for the sample, scanning by a small probe with a size ranged from 10⁻⁹ m to 10⁻⁷ m, i.e. a nano-level size, or by a microsensor is performed in an extremely short distance from the sample surface, and the information for the sample surface which includes the surface structure, the surface morphology, the electric property, the magnetic property, the optical property and the surface potential is obtained thereby. In addition, through a well control for the probe, the nano/micro particles are able to be moved and further deposited on a substrate. Such a measure, however, brings a small transmission amount of particles and hence results in a low efficiency for fabricating the nano/micro structure thereby. Accordingly, the mentioned fabrication on the basis of the scanning probe-based technique has a limitation in the actual application.

The ink jet printing technique is now broadly applied in the image output application. The inks are heated in the jetting zone so as to form micro bubbles therewith. Ink drops are driven by those micro bubbles and then jetting out from the nozzle. The bubbles will last for several microseconds, and the ink drops will be drawn back into the nozzle while the bubbles are broken or vanished, which further results in a suction at the surface of the ink drops. Hence a new ink drop is subsequently attacked and supplemented into the jetting zone thereby. The nano/micro particles, which are well dispersed in the inks, are able to be deposited on a provided substrate while the ink is jetted and printed thereto, so as to assemble the nano/micro structure thereon. Nevertheless, only an extremely thin pattern layer is produced through the mentioned process which makes it difficult to assemble a three-dimensional nano/micro structure with a high efficiency.

The photo-lithography technique has been increasingly developed for the semiconductor technology. The basic processing steps involved in the photo-lithography technique includes photoresist coating, exposing and chemically etching which causes the pollution for the environment and results in a limited application in certain materials. Such a technique is not adopted in the organic or the biological structure fabrication accordingly. Furthermore, the thickness of the structure fabricated thereby is ranged in a submicron level, i.e. a range between 0.01 μm and 1 μm, due to the focal distance. Such a technique is only suitable for fabricating a planar structure but fails to efficiently assemble a three-dimensional nano/micro structure, which has a height larger than 1 μm.

As to the laser tweezers, the principle adopted therein is to control the movement of nano/micro particles via a movable focused laser, so that a nano/micro structure is further formed on the provided substrate thereby. However, since the lens with a large numerical aperture (NA) is necessary for the laser tweezers to focus the laser, hence the operation distance thereof is limited. Therefore, such a technique also fails to assemble a nano/micro structure with an increased scale. In addition, a great amount of energy resulted from the highly focused laser may cause great damage to the material to be assembled, and in particular to the biomaterials to be assembled.

Furthermore, regarding the process for fabricating the nano/micro structure via the laser tweezers, the nano/micro particles are firstly grabbed and transmitted by the laser tweezers and then releases on a certain position of the provided substrate. A two-dimensional or three-dimensional nano/micro structure is assembled on the provided substrate while a repeated process of particle grabbing, transmitting and releasing is performed. However, the amount of the particles transmitted via the laser tweezers is small and the operation distance therefore is short which result in a limited efficiency for the laser tweezers. Therefore, the laser tweezers still fails to be applied for the two-dimensional or three-dimensional nano/micro structure fabrication.

In order to overcome the mentioned drawbacks in this art, a novel apparatus and a method for fabricating a three-dimensional nano/micro structure are provided. In the present invention, plural nano/micro particles are formed to a two-dimensional structure corresponding to an interference pattern formed by plural laser beams and further deposited in a provided substrate, so that a three-dimensional nano/micro structure is deposited in layers thereby. Compared with the conventional apparatuses and methods for the nano/micro structure fabrication, the present invention provides a much simplified apparatus and method for fabricating a three-dimensional nano/micro structure with a high efficiency.

### SUMMARY OF THE INVENTION

In accordance with a first aspect of the present invention, an apparatus for fabricating a three-dimensional nano/micro structure is provided. The apparatus includes a laser source for providing a laser beam, a light-splitting system for generating at least a first light beam and a second light beam from the laser beam, a lens for focusing the first light beam and the second light beam on a focus so as to form an interference pattern thereon and a holder for carrying a substrate having plural first and second nano/micro particles therein.

Preferably, the plural nano/micro particles are formed to a two-dimensional structure corresponding to the interference pattern to be further deposited on the substrate, so that the three-dimensional nano/micro structure is formed thereby.

Preferably, the light-splitting system is one selected from a group consisting of an interferometer, a spectroscope and a reflecting prism.

Preferably, the holder is one of a movable holder and a stationary holder.

Preferably, the further includes a monitoring device for monitoring the formation of the three-dimensional nano/micro structure.

Preferably, the monitoring device is one of a charge coupled device (CCD) and a microscope.

Preferably, the monitoring device is connected to a computer.

In accordance with a second aspect of the present invention, the provided apparatus for fabricating a three-dimensional nano/micro structure includes plural laser sources for providing plural laser beams respectively, a lens for focusing the laser beams on a focus so as to form an interference pattern thereon, and a holder for carrying a substrate having plural first and second nano/micro particles therein, wherein the first and second nano/micro particles are formed as a two-dimensional structure corresponding to the interference pattern to be further deposited on the substrate, so that the three-dimensional nano/micro structure is formed thereby.

Preferably, the holder is one of a movable holder and a stationary holder.

Preferably, the apparatus further includes a monitoring device for monitoring a formation of the three-dimensional nano/micro structure.

Preferably, the monitoring device is one of a charge coupled device (CCD) and a microscope.

Preferably, the monitoring device is connected to a computer.

In accordance with a third aspect of the present invention, a method for fabricating a three-dimensional nano/micro structure is provided. The provided method includes steps of providing a substrate having plural first and second nano/micro particles therein, providing plural laser beams, focusing the laser beams to form an interference pattern, so as to form a two-dimensional structure corresponding to the interference pattern and having the first and second nano/micro particles, and depositing the two-dimensional structure in the substrate so as to successively form the three-dimensional nano/micro structure therein.

Preferably, the method further includes a step of adjusting a position of the substrate relative to the interference pattern for controlling a deposition position of the two-dimensional structure.

Preferably, the method further includes a step of monitoring a formation of the three-dimensional nano/micro structure.

The foregoing and other features and advantages of the present invention will be more clearly understood through the following descriptions with reference to the drawings, wherein:

### BRIEF DESCRIPTION OF THE DRAWINGS

FIG. 1 is a diagram illustrating an apparatus for fabricating a three-dimensional nano/micro structure according to a first preferred embodiment of the present invention;

FIG. 2 is a diagram illustrating an interference pattern with the particles grabbed thereon according to the preferred embodiment of the present invention.

FIG. 3 is a diagram illustrating an apparatus for fabricating a three-dimensional nano/micro structure according to a second preferred embodiment of the present invention; and

FIG. 4 is a flow chart for illustrating the method for fabricating a nano/micro structure according to the preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

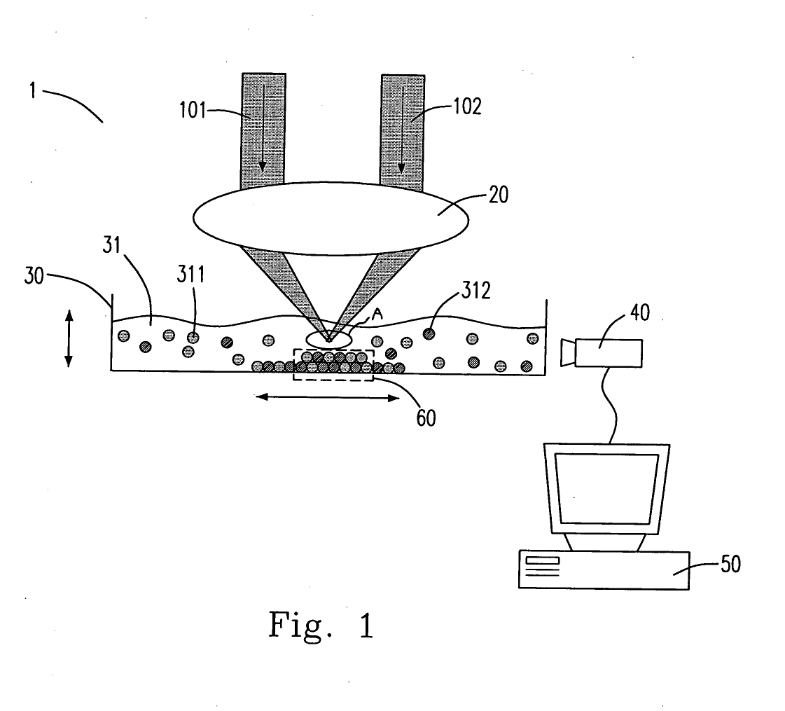

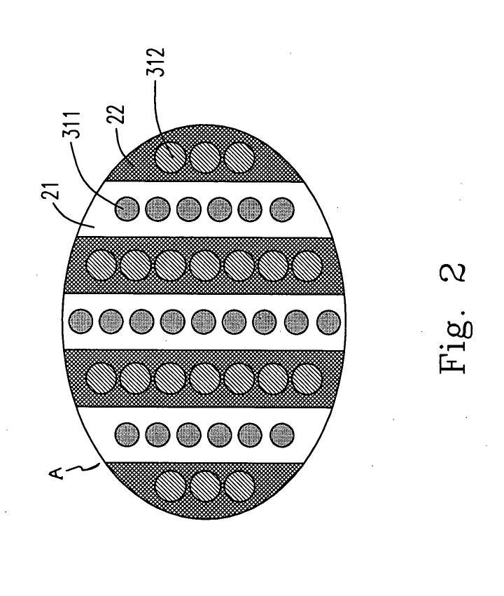

Please refer to FIGS. 1 and 2, which respectively schematically illustrates the apparatus for fabricating a three-dimensional nano/micro structure and the interference pattern with the particles grabbed thereon according to the first preferred embodiment of the present invention. The provided apparatus 1 for fabricating the three-dimensional nano/micro structure 60 includes a laser source, a lens 20, a holder 30 and a monitoring device 40, which is connected to a computer 50. A substrate 31 is carried by the holder 30 and has plural first nano/micro particles 311 and second nano/micro particles therein.

A first laser beam 101 and a second laser beam 102 from the laser source propagating to the lens 20 is focused thereby on a focus and an interference pattern A is further produced thereon due to the optical path difference between the first laser beam 101 and the second laser beam 102. The interference pattern A is shown in FIG. 2 with greater details.

As shown in FIG. 2, the interference pattern A is composed of a series of constructive interference, i.e. the bright fringes 21, and destructive interference, i.e. the dark fringes 22. Such an interference pattern is a result of the phase angle and the optical path difference of the laser beams.

The refraction of a light beam or of a laser beam will be generated while the light beam or the laser beam propagates from a first medium to a second one. That is to say, the light beam or the laser beam may be deviated from its original path. When the light beam or the laser beam is deviated, the photon momentum is changed accordingly which may result in a force for grabbing and holding the dispersed nano/micro particles.

Referring to the interference pattern A shown in FIG. 2, the bright fringes 21 and the dark fringes 22, which are generated from the interference between of the first and second laser beams 101 and 102, respectively denote the constructive interference and the destructive interference having different levels of energy, hence the nano/micro particles grabbed on the bright fringes 21 are different from those grabbed on the dark fringes 22. More specifically, the first nano/micro particles 311 having an increased refraction index relative to the substrate 31 are grabbed on the bright fringes 21, and the second nano/micro particles 312 having a decreased refraction index relative to the substrate 31 are grabbed on the dark fringes 22.

According to the present invention, a multiplicity of nano/micro particles, e.g. the first nano/micro particles 311 and the second nano/micro particles 312, are formed as a two-dimensional structure, i.e. a planar structure, corresponding to the interference pattern A. Through the controlling for the interference pattern A, the planar structure having the first nano/micro particles 311 and the second nano/micro particles 312 is also controllable for further being deposited in the substrate 31, so that the three-dimensional nano/micro structure 60 is formed thereby.

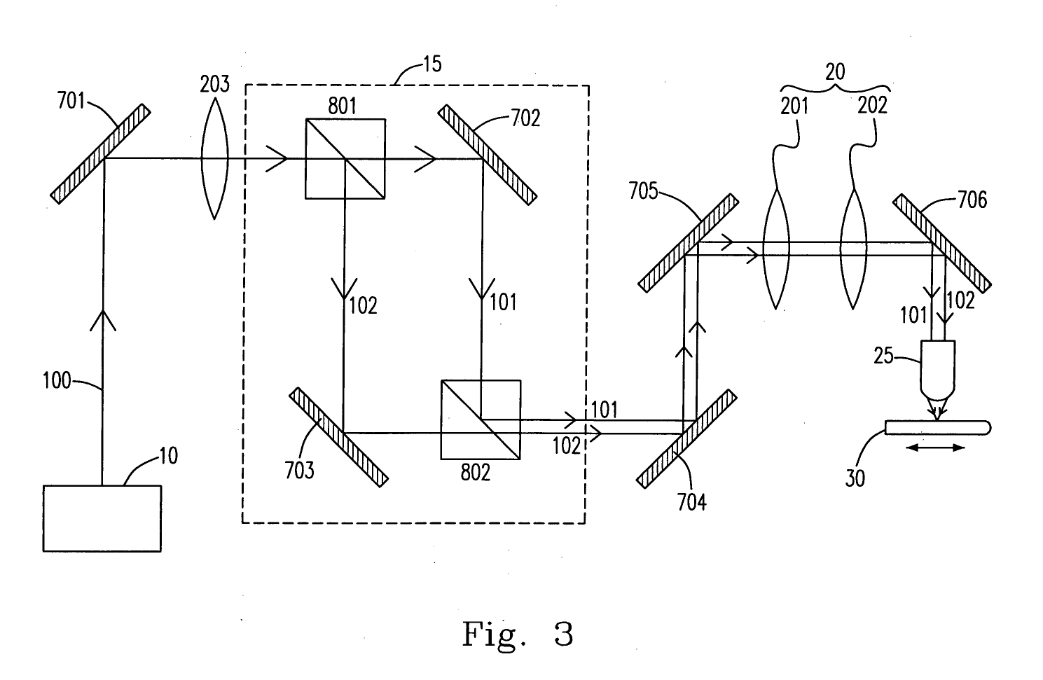

Please refer to FIG. 3, which illustrates an apparatus for fabricating a three-dimensional nano/micro structure according to a second preferred embodiment of the present invention. The apparatus 1 typically includes a laser source 10, a light-splitting system 15, a lens group 20 and a holder 30, wherein the light-splitting system 15 is composed of non-polarizing beam splitters (NPBS) 801 and 802.

A laser beam 100 provided by the laser source 10 is reflected by a reflecting element 701, so as to adjust the propagation direction therefore. Consequently, the laser beam 100 reflected from the reflecting element 701 passes through the lens 203 and is gathered thereby, so that the energy of the laser beam 100 is able to be further collected. Then, the laser beam 100 passes through the light-splitting system 15, and is split into the first laser beam 101 and the second laser beam 102 via the NPBS 801 and the NPBS 802 with the aid of the reflecting elements 702 and 703.

The first laser beam 101 and the second laser beam 102 from the light-splitting system 15 are reflected first by the reflecting element 704 and then by the reflecting element 705, so that the propagation direction therefore is changed. Then, the first laser beam 101 and the second laser beam 102 pass through the lens group 20, and both are gathered thereby for further collecting the energy of the laser beams. Afterward, the first and second laser beams 101 and 102 are reflected again by the reflecting element 706 and pass through an objective 25, by which the interference pattern is produced from the interference of the first and the second laser beams 101 and 102. Accordingly, a two-dimensional nano/micro structure having a multiplicity of nano/micro particles arranged thereon is able to be further grabbed for successively assembling a three-dimensional nano/micro structure on the holder 30.

One point worthy to be mentioned is that, according to the present invention, the reflecting elements 701 to 706 are configured in the apparatus 1 for adjusting the propagation direction for the laser beams. Therefore, the amount and the position thereof are selectable and depend on an actual application, and should not be limited in the configuration as FIG. 3. Moreover, the lens group 20 further includes a first lens 201 and a second lens 202 for further gathering the first and the second laser beams 101 and 102. Furthermore, the holder 30 can be three-dimensionally moved and the position thereof is controllable. This is advantageous to the formation and assembling of the three-dimensional nano/micro structure.

In addition to the mentioned configuration as above, the light-spitting system is also provided with one of an interferometer, a spectroscope, a reflecting prism and other elements, which may result in the light-splitting effect. Of course, it is also preferred to use plural laser sources for providing plural laser beams, so as to further form an interference pattern therefrom.

Furthermore, various two-dimensional nano/micro structures having a multiplicity of nano/micro particles are able to be grabbed by modifying the amount of the laser beams and the interference thereof. Hence the various two-dimensional nano/micro structures are further applied for successively assembling a multiplicity of three-dimensional structures with various configurations.

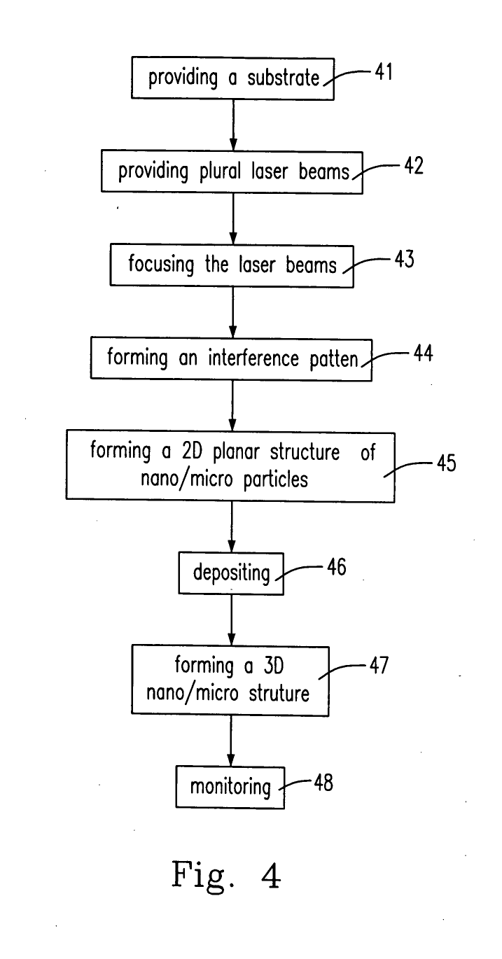

Please refer to FIG. 4, which is a flow chart for illustrating the method for fabricating a nano/micro structure according to the preferred embodiment of the present invention. First, a substrate having at least a plurality of first nano/micro particles and second nano/micro particles is provided as the step 41. Then, plural laser beams are provided as the step 42. The laser beams are focused on a focus by a lens, for example, and an interference pattern is formed from the focused laser beams thereon as the steps 43 and 44, respectively. Afterward, as the step 45, the plural nano/micro particles are formed as a two-dimensional (2D) structure corresponding to the interference pattern respectively, since the refraction index of the first nano/micro particles and that of the second nano/micro particles are different. Referring to the interference pattern, the nano/micro particles having an increased refraction index relative to the substrate are grabbed on the bright fringes of the interference pattern, and on the other hand, the nano/micro particles having a decreased refraction index relative thereto are grabbed on the dark fringes. After being formed on the focus, the two-dimensional structure is further deposited on the substrate, so that a three-dimensional (3D) structure is successively assembled therein as the steps 46 and 47, respectively. Finally, the formation of the three-dimensional nano/micro structure is monitored via a monitoring device, such as a charge coupled device (CCD) or a microscope, as the step 48. In addition, the position of the holder relative to the interference pattern is able to be monitored and adjusted via a computer, for example, in order to control a deposition position of the two-dimensional structure, so as to further improve the assembling for the three-dimensional structure.

According to the present invention, the two dimensional structure having different nano/micro particles is simultaneously grabbed via an interference pattern formed from the laser beams, so as to assemble a three-dimensional nano/micro structure in the substrate in the holder quickly and precisely. The fabricated structure has a line width of a nanometer scale. Besides, the drawback of the material limitation in the conventional apparatus and method is also overcome. Since the photo resists and etching agencies are not necessary for the present invention, the production cost for fabricating the nano/micro structure is efficiently reduced and such a fabrication would not cause damages and pollutions to the environment. Therefore, the present invention not only has a novelty and a progressiveness, but also has an industry utility.

While the invention has been described in terms of what is presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An apparatus for fabricating a three-dimensional nano/micro structure, comprising:
a laser source for providing a laser beam;
a light-splitting system for generating at least a first light beam and a second light beam from said laser beam;
a lens for focusing said first light beam and said second light beam on a focus so as to form an interference pattern thereon; and
a holder for carrying a substrate having plural first and second nano/micro particles therein,
wherein said first and second nano/micro particles are formed as a two-dimensional structure corresponding to said interference pattern to be further deposited on said substrate, so that said three-dimensional nano/micro structure is formed thereby.

2. The apparatus according to claim 1, wherein said light-splitting system is one selected from a group consisting of an interferometer, a spectroscope and a reflecting prism.

3. The apparatus according to claim 1, wherein said holder is one of a movable holder and a stationary holder.

4. The apparatus according to claim 1, further comprising a monitoring device for monitoring a formation of said three-dimensional nano/micro structure.

5. The apparatus according to claim 4, wherein said monitoring device is one of a charge coupled device (CCD) and a microscope.

6. The apparatus according to claim 5, wherein said monitoring device is connected to a computer.

7. An apparatus for fabricating a three-dimensional nano/micro structure, comprising:
plural laser sources for providing plural laser beams respectively;
a lens for focusing said laser beams on a focus so as to form an interference pattern thereon; and
a holder for carrying a substrate having plural first and second nano/micro particles therein,
wherein said first and second nano/micro particles are formed as a two-dimensional structure corresponding to said interference pattern to be further deposited on said substrate, so that said three-dimensional nano/micro structure is formed thereby.

8. The apparatus according to claim 7, wherein said holder is one of a movable holder and a stationary holder.

9. The apparatus according to claim 7, further comprising a monitoring device for monitoring a formation of said three-dimensional nano/micro structure.

10. The apparatus according to claim 9, wherein said monitoring device is one of a charge coupled device (CCD) and a microscope.

11. The apparatus according to claim 10, wherein said monitoring device is connected to a computer.

12. A method for fabricating a three-dimensional nano/micro structure, comprising steps of:
(a) providing a substrate having plural first and second nano/micro particles therein;
(b) providing plural laser beams;
(c) focusing said laser beams to form an interference pattern, so as to form a two-dimensional structure corresponding to said interference pattern and having said first and second nano/micro particles; and
(d) depositing said two-dimensional structure on said substrate so as to successively form said three-dimensional nano/micro structure therein.

13. The method according to claim 12, wherein step (d) further comprises a step of:
adjusting a position of said substrate relative to said interference pattern for controlling a deposition position of said two-dimensional structure.

14. The method according to claim 12, wherein step (d) further comprises a step of:
monitoring a formation of said three-dimensional nano/micro structure.
